(19) United States
(12) Patent Application Publication
(10) Pub. No.: US 2013/0004106 A1
(43) Pub. Date: Jan. 3, 2013

(54) DIAMOND BEARING ASSEMBLY

(76) Inventor: Kenneth H. WENZEL, Edmonton (CA)

(21) Appl. No.: 13/537,974

(22) Filed: Jun. 29, 2012

(30) Foreign Application Priority Data
Jun. 29, 2011 (CA) 2 744 955

(51) Int. Cl. F16C 35/00

(52) U.S. Cl. 384/428

(57) ABSTRACT

A diamond bearing assembly includes a first diamond bearing carrier and a second diamond bearing carrier. At least one industrial diamond is mounted on the first diamond bearing carrier, with each industrial diamond mounted on the first diamond bearing carrier defining a convex bearing surface. At least one industrial diamond is mounted on the second diamond bearing carrier, with each industrial diamond mounted on the second diamond bearing carrier defining a concave bearing surface. The concave bearing surfaces of the industrial diamonds on the second diamond bearing carrier accommodate and are in relative sliding engagement with the convex bearing surfaces of the industrial diamonds on the first diamond bearing carrier. This diamond bearing assembly can accommodate limited misalignment.

### FIELD

There is described a diamond bearing assembly that will accept limited misalignment.

### BACKGROUND

Diamond bearings must be precisely aligned in order to function properly. What is required is a diamond bearing assembly that can accommodate limited misalignment.

### SUMMARY

There is provided a diamond bearing assembly which includes a first diamond bearing carrier and a second diamond bearing carrier. At least one industrial diamond is mounted on the first diamond bearing carrier, with each industrial diamond mounted on the first diamond bearing carrier defining a convex bearing surface. At least one industrial diamond is mounted on the second diamond bearing carrier, with each industrial diamond mounted on the second diamond bearing carrier defining a concave bearing surface. The concave bearing surfaces of the industrial diamonds on the second diamond bearing carrier accommodate are in relative sliding engagement with the convex bearing surfaces of the industrial diamonds on the first diamond bearing carrier.

There will hereinafter be described a preferred embodiment of diamond bearing assembly. In the preferred embodiment, there is more than one industrial diamond mounted to each of the first diamond bearing carrier and the second diamond bearing carrier. This provides a greater range of movement. The industrial diamonds may be arranged in different ways, such as in one or more rows or other patterns that ensure continuous contact and the appropriate radius. In the preferred embodiment, the first diamond bearing carrier has a convex mounting surface on which the industrial diamonds are mounted and the second diamond carrier has a concave mounting surface on which the industrial diamonds are mounted. This accommodates rotational, along with limited omni-directional movement. In the preferred embodiment, the convex mounting surface is encircled by industrial diamonds, as is the concave mounting surface is encircled by industrial diamonds.

The diamond bearing assembly described can accommodate relative movement of the first body and the second body, which results from misalignment. It will be appreciated, that the diamond bearing will be more effective if the convex bearing surface is at all times maintained in engagement with the concave bearing surface during such movement.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded perspective view of a diamond bearing assembly.

FIG. 2 is an exploded side elevation view, in section, of the diamond bearing assembly illustrated in FIG. 2.

FIG. 3 is a side elevation view, in section, of the diamond bearing assembly illustrated in FIG. 1 and FIG. 2.

FIG. 4 is an enlarged detailed side elevation view, in section, of a bearing surface engaging the diamond bearing assembly illustrated in FIG. 3.

FIG. 5 is a side elevation view, in section, of an alternative diamond bearing assembly.

### DETAILED DESCRIPTION

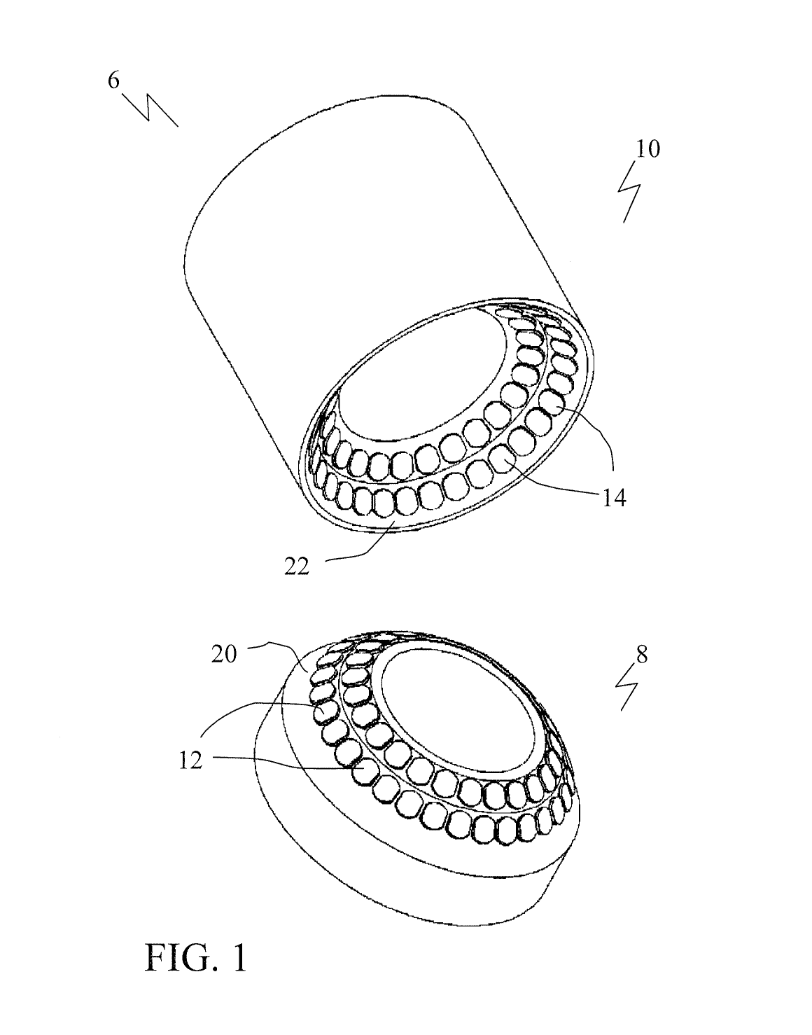

A diamond bearing assembly generally identified by reference numeral 6, will now be described with reference to FIG. 1 through FIG. 5.

### Structure and Relationship of Parts:

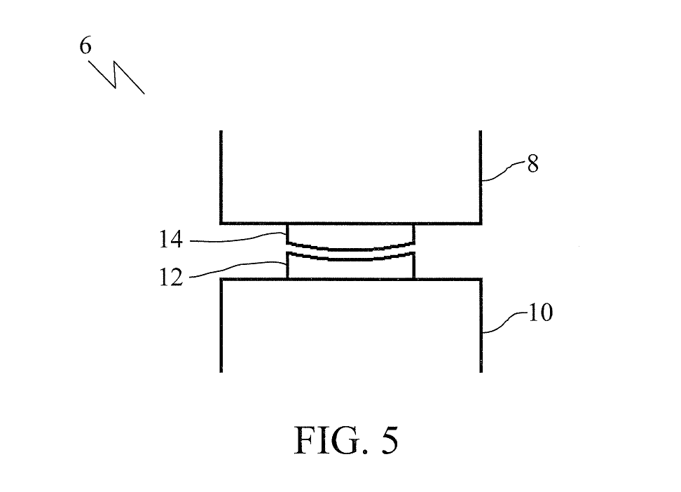

Referring to FIG. 1, a diamond bearing assembly 6 includes a first diamond bearing carrier 8 and a second diamond bearing carrier 10. One or more industrial diamonds 12 are mounted on first diamond bearing carrier 8. One or more of industrial diamonds 14 are mounted on second diamond bearing carrier 10. FIG. 1 is an example of a plurality of industrial diamonds 14, while FIG. 5 is an example of a bearing assembly 6 with only one industrial diamond 12 and 14 on carriers 8 and 10, respectively.

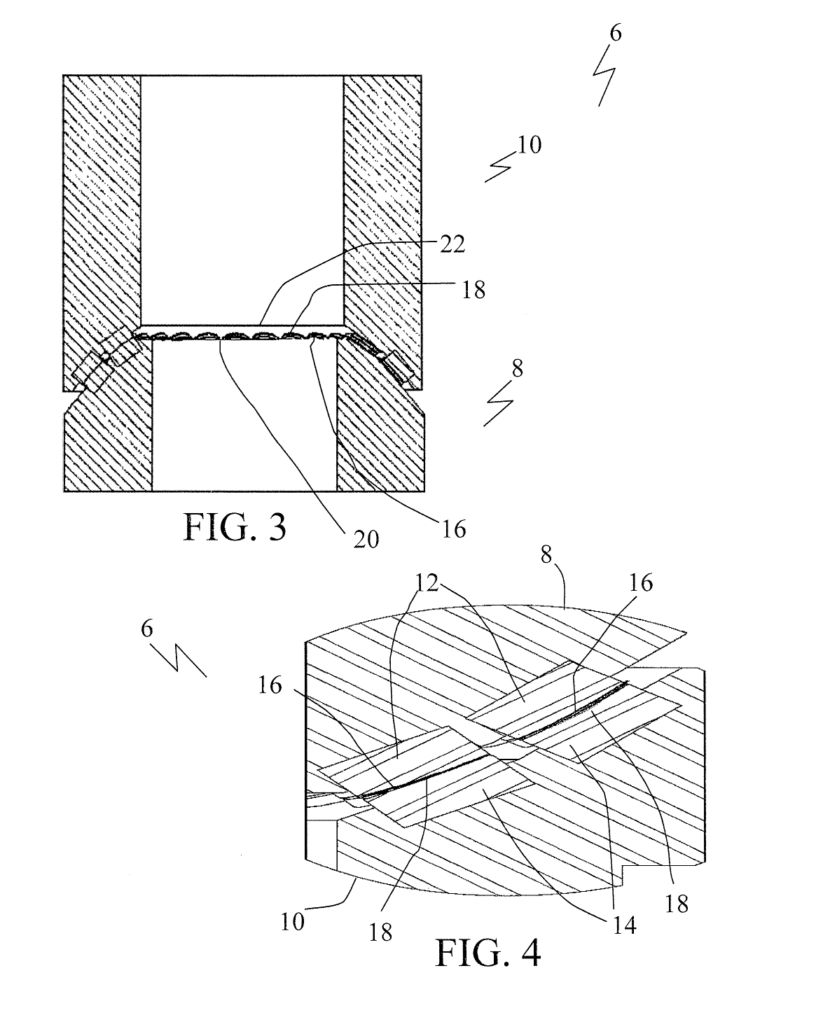

Referring to FIG. 4, each of industrial diamonds 12 defines a convex bearing surface 16. Each of industrial diamonds 14 define a concave bearing surface 18, which accommodates convex bearing surface 16. Referring to FIG. 3, convex bearing surface 16 is maintained in continual sliding engagement with concave bearing surface 18. This is accomplished by using a preload. There are various ways in which a preload may be achieved. Mechanisms for exerting a preload are well known. Examples of mechanisms for placing a preload on bearings includes: adjusting nuts, shims, mechanical springs, and through hydraulic pressure. As the manner of preload does not form part of the invention, it has not been illustrated and will not be further described.

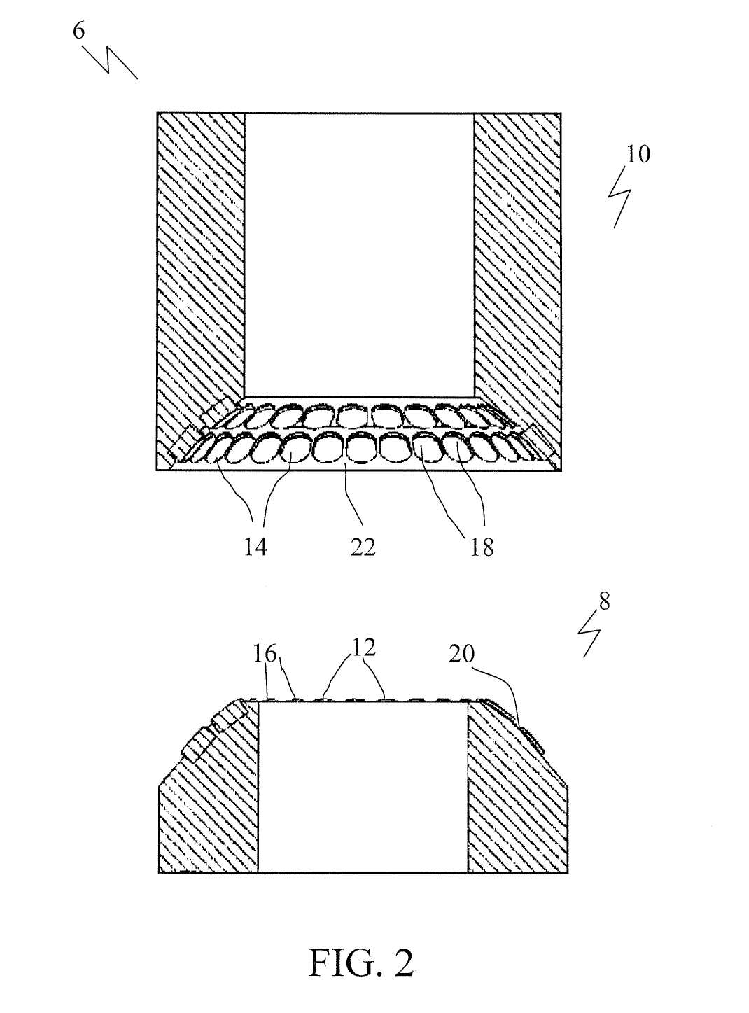

The principle of using industrial diamonds with mating convex and concave surfaces can be applied when a single industrial diamond 12 is used with a single industrial diamond 14. In the tubular application illustrated, more than one industrial diamond 12 is used with more than one industrial diamond 14. Referring to FIG. 1 and FIG. 2, first diamond bearing carrier 8 has a convex mounting surface 20 on which industrial diamonds 12 are mounted and second diamond carrier 10 has a concave mounting surface 22 on which industrial diamonds 14 are mounted. Industrial diamonds 12 are arranged in circumferential rows which encircle convex mounting surface 20. Similarly, industrial diamonds 14 are arranged in circumferential rows that encircle cave mounting surface 22.

### Operation

Referring to FIG. 4, the complementary shape of industrial diamonds 12 and industrial diamonds 14 allows diamond bearing assembly 6 to accommodate relative movement of first diamond bearing carrier 8 and second diamond bearing carrier 10 caused by misalignment without a negative impact on the ability of the diamond bearing assembly to function properly. Any misalignment that occurs is accommodated by relative sliding movement of convex bearing surface 16 and concave bearing surface 18.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A diamond bearing assembly, comprising:
a first diamond bearing carrier;
at least one industrial diamond mounted on the first diamond bearing carrier, each industrial diamond mounted on the first diamond bearing carrier defining a convex bearing surface;
a second diamond bearing carrier;
at least one industrial diamond mounted on the second diamond bearing carrier, each industrial diamond mounted on the second diamond bearing carrier defining a concave bearing surface, which accommodates and is in relative sliding engagement with one or more of the convex bearing surfaces of at least one industrial diamond on the first diamond bearing carrier.

2. The diamond bearing assembly of claim 1, wherein there is more than one industrial diamond mounted to each of the first diamond bearing carrier and the second diamond bearing carrier.

3. The diamond bearing assembly of claim 1, wherein the first diamond bearing carrier has a convex mounting surface on which the industrial diamonds are mounted and the second diamond carrier has a concave mounting surface on which the industrial diamonds are mounted.

4. The diamond bearing assembly of claim 3, wherein the convex mounting surface is encircled by industrial diamonds and the concave mounting surface is encircled by industrial diamonds.
